(19) United States
(12) Patent Application Publication
(10) Pub. No.: US 2011/0030355 A1
(43) Pub. Date: Feb. 10, 2011

(54) Catalytic Converter and Process of Manufacture

(75) Inventors: Daniel C. Gilmer, Commerce Township, MI (US); Jeffery M. Destrampe, Willis, MI (US)

Correspondence Address: WOOD, HERRON & EVANS, LLP, 2700 CAREW TOWER, 441 VINE STREET, CINCINNATI, OH, 45202, US

(73) Assignee: VCONVERTER COMPANY, Whitemore Lake, MI (US)

(21) Appl. No.: 12/538,352

(22) Filed: Aug. 10, 2009

(51) Int. Cl. F01N 3/28; B32B 37/00; B32B 38/00; B23K 20/00

(52) U.S. Cl. 60/299; 156/60; 156/91; 228/175; 29/890

(57) ABSTRACT

A catalytic converter cartridge comprises multiple square, rectangular or other flat sided catalyst coated substrates, each substrate of which has each of its flat sides covered by a compressible mat material. These multiple mat covered substrates or modules are arranged into a multiple module array enclosed within a metal shell with each module preferably separated from adjacent modules by sheet metal spacers.

### FIELD OF THE INVENTION

The present invention relates to exhaust systems for combustion engines and, more particularly, to a catalytic converter cartridge for use in such systems. In accordance with this invention, the catalytic converter cartridge is in the shape of rectangular, square, triangular or other flat sided cartridge.

### BACKGROUND OF THE INVENTION

Exhaust systems for a combustion engine generally include a manifold connected to the combustion engine at one end and bolted to an exhaust pipe at the other end. The exhaust pipe extends a distance from the manifold and generally has a catalytic converter system bolted thereto. These catalytic converter systems generally include a ceramic substrate having a catalyst coated thereon and a metal housing or shell surrounding the substrate. A compressible support mat is usually placed between the ceramic substrate and the surrounding metal housing shell. This support mat functions to accommodate differentials in expansion between the ceramic substrate and the surrounding metal housing shell, as well as to protect the relatively fragile ceramic substrate from vibration and jarring movement of the engine and exhaust system so well as to accommodate variances in the shape and size of the substrate and metal shell.

Relatively recently, there has developed a market for rectangular or square cross section substrates, particularly for use in large engine applications. The practice, because such converters are so large, has been to make the converter of multiple substrate modules, assemble them into an array and then slide the assembly into a single large sheet metal frame. One advantage of this practice is that the converter may be adjusted and sized for varying applications by adding additional rows of modules having a common service part.

There are three fundamental problems with rectangular or square cross section converters which must be overcome before such converters can be economically manufactured. The first problem occurs as a consequence of the relative fragility of the ceramic substrates. The corners are so fragile that the typical mounting mat design will over-compress and crack the ceramic.

The second problem occurs because the traditional “stuffing operation” and the traditional tourniquet wrap operation conventionally used commercially to encase round, oval or “race track” cross sectional-shaped modules within a sheet metal shell will damage and crack square or rectangular cross sectional-shaped substrates.

The third problem occurs as a consequence of the lack of flatness of the sides of a flat sided ceramic substrate. The last step in the manufacture of a ceramic substrate is one of baking or heating to cure the substrate. But in the course of baking the substrate, the substrate shrinks more at the center of a side than at the edges with the result that the center of one side will shrink more than the corners. For example, a six inch cube of substrate may shrink two or three millimeters at the center of one side and only one millimeter at the corner. When this substrate is encased in a compressible mat, six millimeters in thickness for example, and then forced onto a metal shell, there will be substantially more compression and holding force of the mat at the corners than at the center of the substrate because of this slight concavity of the sides of the substrate. This greater compression of the mat at the corners of the substrate often causes breakage of the corners of the substrate.

It has therefore been an objective of this invention to provide a rectangular, square or other flat sided catalytic converter which overcomes all of the problems of corner cracking of the substrates during assembly of the mats and substrates within metal shells.

### SUMMARY OF THE INVENTION

The disclosure of this invention comprises a catalytic converter cartridge having multiple rectangular or square cross sectional modules, each module of which comprises a catalyst coated ceramic or other conventional material substrate surrounded and retained within a compressible supporting mat. The multiple modules are assembled into a rectangular, square or other flat sided package or array which is then surrounded and retained within a sheet metal shell. Preferably, the individual modules are separated by sheet metal spacers.

In a preferred embodiment of this invention, the compressible mat surrounding each of the sides of the ceramic substrate is in the shape of individual flat sheets of compressible mat material shaped to cover each side of the substrate and with each sheet of mat material connected by a tongue and groove connector to the mat on each of the adjacent sides of the substrate. Those flat sheets of mat material are preferably glued or otherwise adhesively secured to the flat sides of the substrate such that all sides of the substrate are covered and secured to mat material.

In one preferred embodiment, the complete cartridge is assembled by placing multiple modules in an array separated by sheet metal spacers. These spacers comprise slotted sheets of sheet metal assembled into a right angular relationship with two modules contacting each side of the spacer. The assembly is then compressed and placed in a surrounding sheet metal shell. The shell in one embodiment comprises two right angular bent sheets of metal seam welded at the corners to create a rectangular shell. An appropriate number of tack welds are then made between the spacers and the surrounding sheet to hold the complete cartridge in an assembled relationship.

This invention will be more readily apparent from the following description of the drawings, in which:

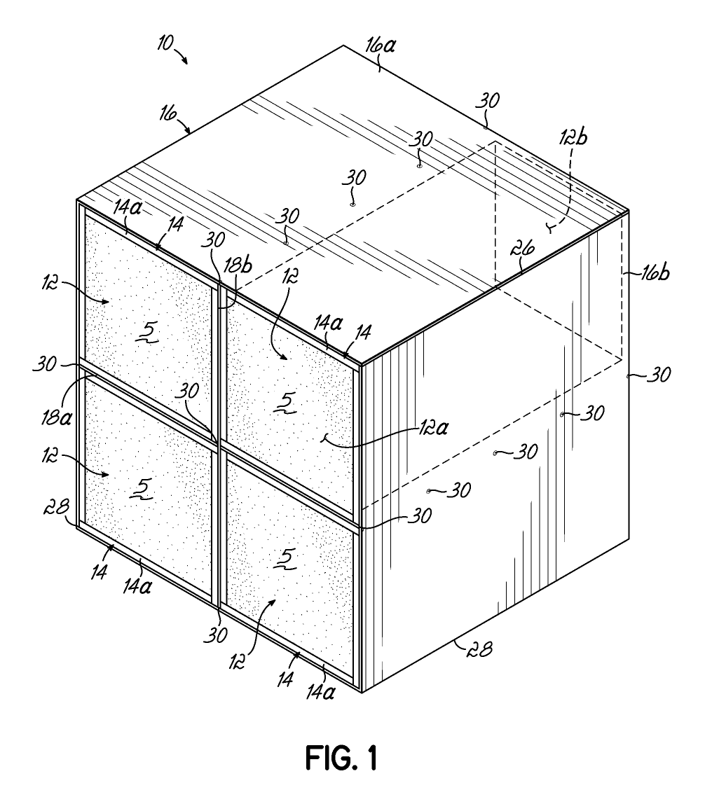

FIG. 1 is a perspective view of the assembled catalytic converter cartridge of the invention;

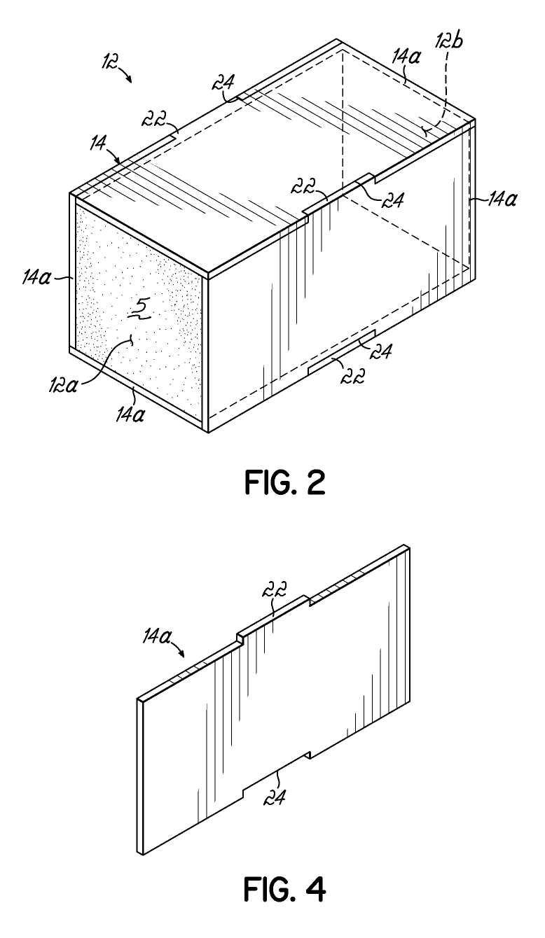

FIG. 2 is a perspective view of one module of the catalytic converter cartridge of FIG. 1;

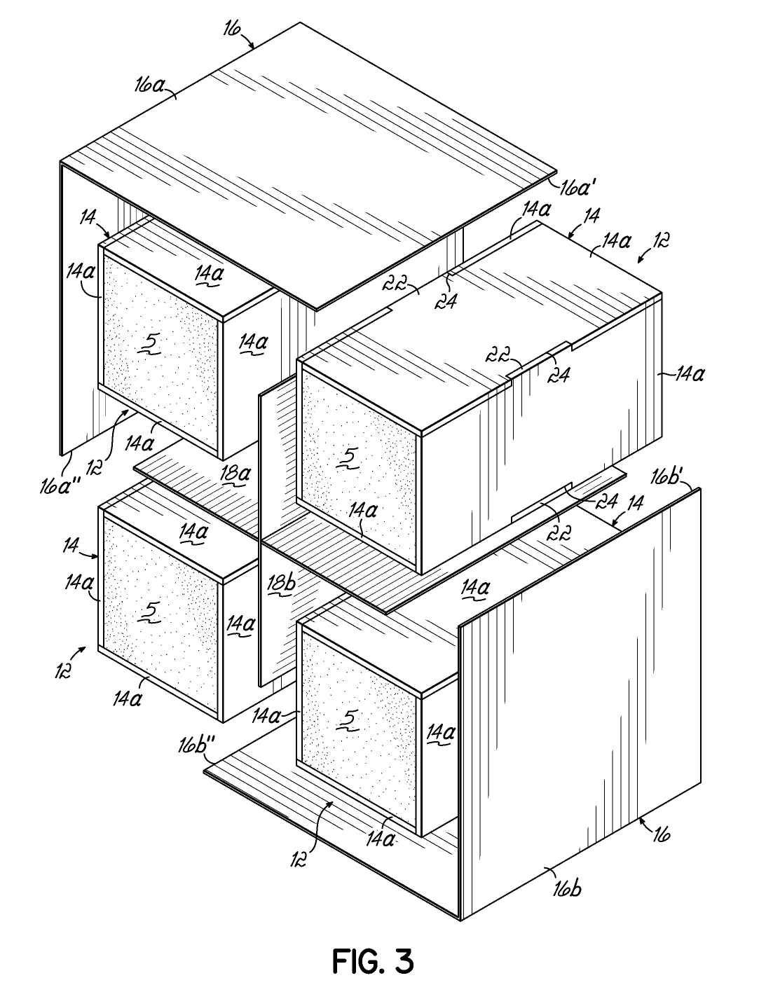

FIG. 3 is an exploded perspective view of the unassembled cartridge of FIG. 1;

FIG. 4 is a perspective view of one side of tongue and groove-shaped mat material used in the cartridge of FIG. 1;

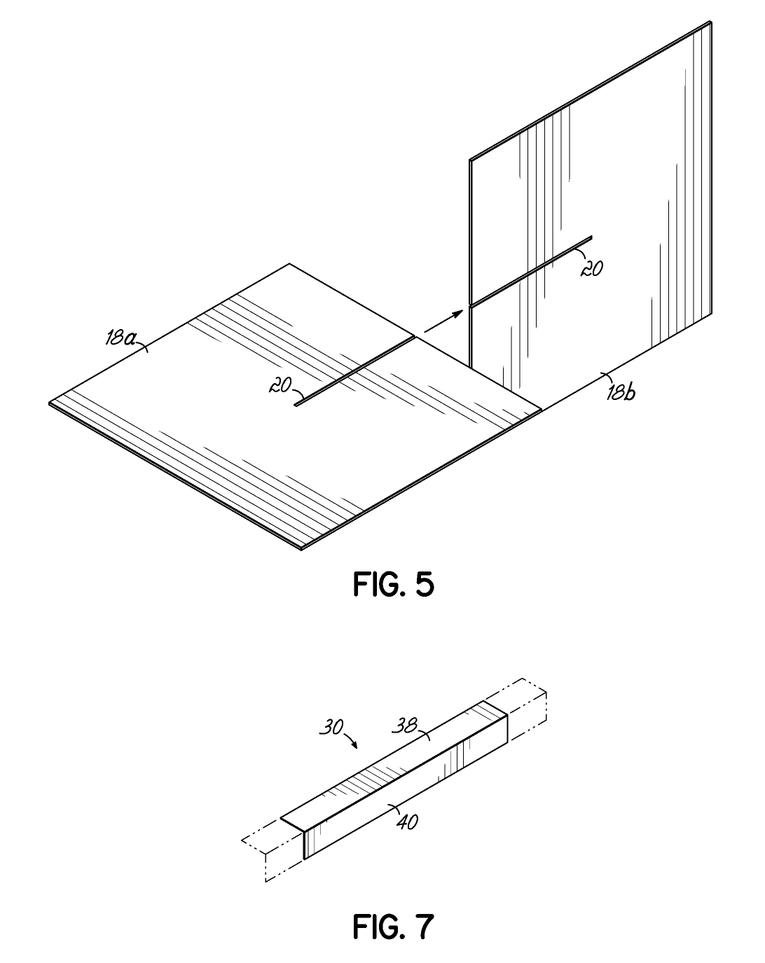

FIG. 5 is an exploded perspective view of two sheet metal spacers used in the cartridge of FIG. 1;

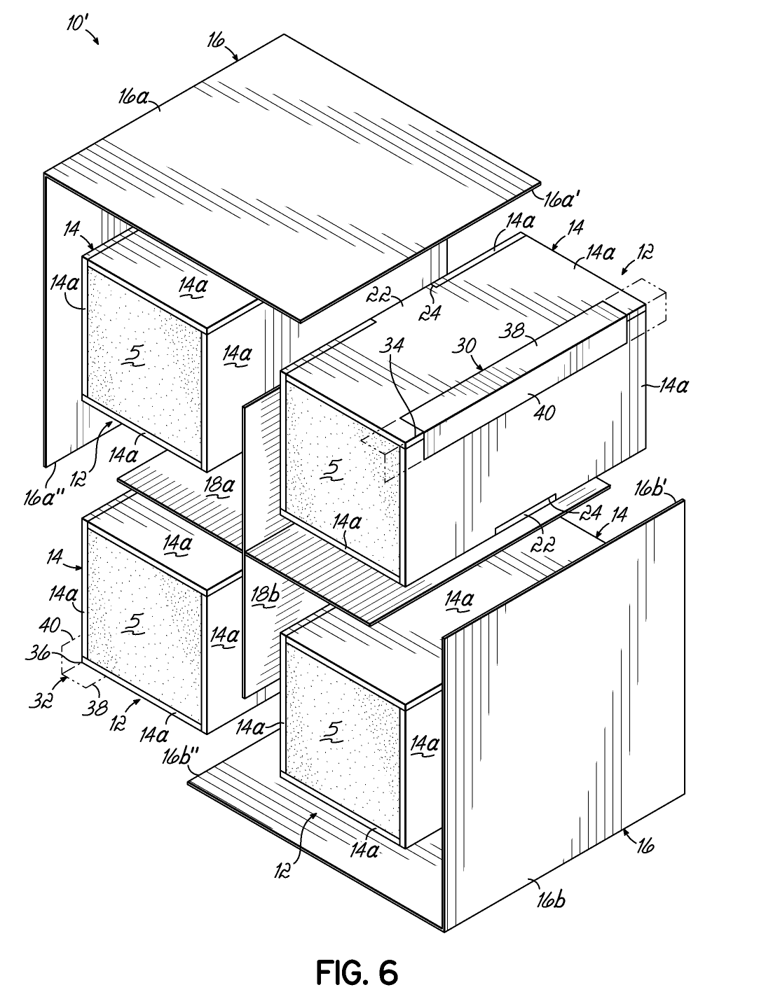

FIG. 6 is an exploded perspective view of the unassembled cartridge similar to FIG. 3, but illustrating an alternative method of assembly of the cartridge; and

FIG. 7 is a perspective view of one corner assembly aid used in the embodiment of FIG. 6.

### DETAILED DESCRIPTION OF THE INVENTION

With reference to FIG. 1, there is illustrated one preferred embodiment of a catalytic converter cartridge 10 incorporating the invention of this application. As there illustrated, this cartridge comprises four ceramic substrate modules 12 (FIG. 2) arranged in a cubular array. Each ceramic substrate 5 of each module 12 has a front face surface 12a, a rear face surface 12b and is surrounded on its four sides and retained within a compressible supporting mat 14. The four assembled modules 12 are surrounded and retained within a sheet metal shell 16. Located between the modules 12, there are sheet metal spacers 18a, 18b.

As best illustrated in FIGS. 3 and 5, the sheet metal spacers comprise two sheets 18a, 18b of sheet metal having medial slots 20 extending from one side thereof for one-half the height of the spacer. The spacer sheets 18a, 18b are assembled into a right angular relationship with the medial slot 20 of one sheet 18a extending over the unslotted portion of the other sheet 18b and the slot 20 of the sheet 18b extending over the unslotted portion of the sheet 18a in the fashion of egg crate partitions.

With reference now to FIG. 4, there is illustrated a sheet of resilient mat material 14a used to cover each of the four sides of each ceramic substrate module 12. As there illustrated, each sheet 14a of matting material is rectangular in shape and sized to cover one side of each substrate 5. Each sheet 14a has a tongue 22 formed on one edge (the top edge, as illustrated in FIG. 4) and a correspondingly shaped and sized groove 24 on the opposite side. One such sheet of mat material is adhesively secured to each of the four sides of each ceramic substrate 5 with a tongue 22 of one sheet 14a extending into the groove of the adjacent sheet of matting material 14a, as best illustrated in FIG. 2.

In the course of manufacturing the catalytic converter cartridge 10, the sheets of cold mat material 14a are first cut and sized so as to cover the four sides of the substrate 5. The substrate is preferably a catalyst coated ceramic substrate. Each substrate 5 is then secured within the covering mat material by having four sheets of mat material 14a fixedly secured to the four sides of the substrate, as illustrated in FIG. 2. The sheets of matting material are preferably adhesively secured to the sides of the substrate so as to facilitate assembly of the matting material and the substrate.

The four mat covered substrates are arranged in a square or rectangular array as illustrated in FIG. 3 with the sheet metal spacers 18a, 18b located between adjacent modules 12. The rectangular array of modules 12, with the spacers located therebetween, are then encased within the sheet metal shell 16.

As best illustrated in FIG. 3, the sheet metal shell comprises two sheets 16a, 16b of preformed metal bent at right angles and welded together at their adjacent corners 26, 28. The corner welds 26a, 28a are initially tack welds used to hold the whole assembly under compression of the mat material after which the corners 26, 28 are preferably seam welded. Additionally, there are spot welds 30 between the sheet metal spacers 18a, 18b and the sheet metal shell 16 so as to hold the catalytic converter cartridge 10 in an assembled relationship.

In the practice of this invention, the sheet metal spacers 18a, 18b may, in some cases, be omitted, but in the event that spacers are used, the sheet metal spacers and the sheet metal shell are preferably made from stainless steel to facilitate use of the cartridge in an environment in which other steels would be adversely affected by the environment in which the catalytic converter cartridges are utilized.

In the course of assembly, the cartridge 10, and as best illustrated in FIG. 3, the modules 12 are first assembled into an array with the spacers 18a, 18b separating all adjacent modules. The assembled array may temporarily be held in an assembled relationship by tape (not shown) or the tape may be omitted as the two preformed and sized right angle bent sheets 16a, 16b of the metal shell 16 are moved inwardly toward one another over the assembled array so as to compress the array and mats of the array until the edges 16a′, 16a″ of the sheet 16a contact and are initially tack welded to the edges 16b′, 16b″ of sheet 16b. These initial temporary tack welds are then followed by full seam welds 26, 28 to complete the assembly.

With reference now to FIG. 6, there is illustrated another different embodiment of cartridge 10′ substantially identical to the cartridge 10, but assembled in a slightly different manner or method than the cartridge 10. In this second embodiment of cartridge 10′, those components of the cartridge identical to the components of FIGS. 1-5 have been given identical numerical designations.

With reference to FIG. 6, it will be seen that the only difference in this embodiment from that illustrated in FIG. 3 is the inclusion of two corner assembly aids 30, 32. These corner assembly aids 30, 32 are placed over the two corners 34, 36 of the assembled array of modules 5 before the two sheets 16a, 16b of the shell 16 are moved toward one another over the array so as to compress the array inwardly. The function of these two corner assembly aids 30, 32 is to prevent the mat material from being squeezed outwardly at the corners when the array is compressed between the two sheets 16a, 16b of metal shell 16 during assembly of the cartridge. In the absence of these corner assembly aids, mat material is prone to be squeezed at the corners 34, 36 and forced outwardly to create a potential production problem and source of blow by exhaust in use of the cartridge.

With reference now to FIG. 7, there is illustrated one corner assembly aid 30, the other aid 32 being identical to the aid 30. This aid 30 comprises a thin sheet of plastic bent with a right angle configuration having two sides 38, 40 which fit over the corners 34, 36 of the corner modules 5. These aids may either be left in place as the sheet metal shell 16 is assembled over the assembled array of modules or, if the aids are made longer than the modules, as illustrated in phantom in FIGS. 6 and 7, the corner assembly aids 30, 32 may be pulled from the assembly after the metal shell has been placed over the array of modules and the modules with their surrounding mats been placed in compression by the assembled shell 16.

In one preferred embodiment of this invention, the substrate 5 is a conventional catalyst-coated ceramic substrate, but of course, other conventional substrates could be utilized in the practice of this invention. The compressible mat material 14 is, in one embodiment, a cold hold material identified as XPE-MP available from Unifax Corp. of Niagara Falls, N.Y., but of course, other conventional mat materials could be used in the practice of this invention. These sheets of mat material are preferably adhesively secured to the four sides of the substrate by a conventional sprayed adhesive. One suitable adhesive utilized in the practice of the invention is Super77 Spray adhesive manufactured by Minnesota Mining & Manufacturing Co. (3M). In one preferred embodiment of the invention, the sheet metal spacers and the metal shell are manufactured from 304 stainless steel, but of course, other spacers and shell materials could be utilized in the practice of this invention, depending upon the application of the cartridge. Furthermore, in some applications, the spacers 18a, 18b may be omitted.

As illustrated in the one preferred embodiment of the invention illustrated and described hereinabove, substrates 5 are in the shape of a cube, but they could as well be shaped as other rectangular parallelepipeds or even triangular cross sectional solids. Additionally, there could be more than four modules 12 of varying shape enclosed within a shell, and there could be more than one cartridge 10 utilized to make up a complete catalytic converter.

We have also illustrated the flat sheets of mat material as being interconnected by one tongue and groove connection, but there could, of course, be more than one tongue and groove connection between each pair of sheets of mat material, or the tongue and groove connections could, in some applications, even be omitted if the mats and metal shell are sufficiently accurately sized so as to avoid blow by of exhaust gases in applications of the cartridges in catalytic converters.

While we have illustrated and described several preferred embodiments of this invention, persons skilled in this art will appreciate further changes and modifications which may be made without departing from the spirit of our invention.

We claim:

1. A catalytic converter cartridge comprising:
a plurality of catalytic converter modules assembled into an array;
each of said modules comprising an inner substrate having a front surface, a rear surface and a plurality of flat sides, a compressible mat surrounding all sides of each substrate, each compressible mat surrounding each substrate comprising individual sheets of mat material secured to each flat side of each substrate; and
a sheet metal shell surrounding said assembled modules.

2. The cartridge of claim 1 wherein said sheets of mat material are adhesively secured to the sides of each substrate.

3. The cartridge of claim 1 wherein said sheets of mat material surrounding each substrate are connected one to the next by at least one tongue and groove connection.

4. The cartridge of claim 1 wherein there are sheet metal spacers located between and separating each module of the cartridge from an adjacent module.

5. The cartridge of claim 4 wherein said sheet metal spacers are connected to said sheet metal shell by tack welds.

6. A catalytic converter cartridge comprising:
a plurality of catalytic converter modules assembled into an array;
each of said modules comprising an inner ceramic substrate having a front surface, a rear surface, a plurality of flat sides and a compressible mat surrounding all flat sides of each ceramic substrate;
sheet metal spacers located between and separating each module of the cartridge from an adjacent module; and
a sheet metal shell surrounding said assembled modules.

7. The cartridge of claim 6 wherein said sheet metal spacers are connected to said sheet metal shell by tack welds.

8. The cartridge of claim 6 wherein said compressible mat surrounding each module comprises individual sheets of mat material secured to each of the sides of each module.

9. The cartridge of claim 8 wherein said sheets of mat material are adhesively secured to the sides of the substrate.

10. The cartridge of claim 8 wherein said sheets of mat material surrounding each module are connected one to the next by a tongue and groove connection.

11. A method of assembling a catalytic converter cartridge comprising a plurality of catalytic converter modules with each of said modules having an inner substrate having a front surface, a rear surface and a plurality of flat sides and a compressible mat surrounding all sides of each substrate, which method comprises:
attaching said mat material in the form of flat sheets of mat material to each of the flat sides of said substrates;
assembling said plurality of mat covered modules into an array;
placing multiple preformed parts of a metal shell over the assembled array of modules;
moving the preformed parts of said metal shell inwardly toward one another so as to place said array and said mat material in compression;
securing together corners of metal shell parts while said array is held in compression.

12. The method of claim 11 wherein said sheets of mat material are adhesively secured to the sides of each substrate.

13. The method of claim 11 which further comprises the steps of forming at least one tongue on one side of each sheet of mat material and at least one groove on the opposite side of each sheet of mat material; and
connecting each sheet of mat material by placing the at least one tongue of a sheet of mat material in the groove of the adjacent sheet of mat material.

14. The cartridge of claim 11 which further comprises the step of placing sheet metal spacers between each module of the cartridge so as to separate each module from an adjacent module.

15. The cartridge of claim 14 which further comprises the step of tack welding said sheet metal spacers to said sheet metal shell to hold the cartridge in an assembled relationship.

16. The method of claim 11 which further comprises the step of placing angled corner assembly sides beneath each of said corners of said metal shell parts before said metal shell parts are moved inwardly to place said array in compression.

17. A method of assembling a catalytic converter cartridge comprising a plurality of catalytic converter modules, each module of which has an inner ceramic substrate having a front surface, a rear surface, a plurality of flat sides and a compressible mat surrounding all flat sides of the ceramic substrate, which method comprises:
assembling said plurality of modules onto an array;
placing sheet metal spacers between adjacent modules of said array;
placing multiple preformed parts of a metal shell over the assembled array of modules;
moving the preformed parts of said metal shell inwardly toward one another so as to place said array and said mat material of said array in compression;
securing together corners of said metal shell while said array is held in compression.

18. The method of claim 17 wherein said corners of said metal shell are at least initially secured together by tack welding said corners together.

19. The method of claim 17 which comprises the further step of securing said sheet metal spacers to said sheet metal shell by tack welding said spacers to said metal shell.

20. The method of claim 17 which comprises the further step of forming said mat material into flat sheets of mat material and securing one individual sheet of mat material to each of the sides of each module.

21. The method of claim 20 which comprises the step of adhesively securing said sheets of mat material to the sides of the substrates.

22. The method of claim 20 which comprises the step of forming at least one tongue on one side of each sheet of mat material and a groove on the opposite side of each sheet of mat material and assembling said material to said substrate by placing said at least one groove of one sheet of material in said at least one groove of the next adjacent sheet of mat material.

23. The method of claim 17 which further comprises the step of placing angled corner assembly sides beneath each of said corners of said metal shell parts before said metal shell parts are moved inwardly to place said array in compression.
